(19) United States
(12) Patent Application Publication
(10) Pub. No.: US 2007/0213995 A1
(43) Pub. Date: Sep. 13, 2007

(54) Methods, systems, and computer program products for implementing a mobile referral system

(76) Inventor: Curtis M. Wall, McDonough, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/374,524

(22) Filed: Mar. 13, 2006

(51) Int. Cl. G06Q 10/00; G06Q 30/00; G07G 1/14

(52) U.S. Cl. 705/1; 705/14

(57) ABSTRACT

Methods, systems, and computer program products for implementing a mobile referral system are provided. The method includes presenting a referral form on a mobile device display, the referral form including data fields for receiving information and selections from a referring individual. The data fields include customer contact information fields, a customer type, and a referral type. Upon receiving the information and selections, the method includes determining a target destination for the referral based upon at least one of the customer type and the referral type, associating an identifier of the referring individual with the referral, and transmitting the referral and the identifier of the referring individual to the target destination.

### BACKGROUND

The present invention relates generally to communications systems, and more particularly, to methods, systems, and computer program products for implementing a mobile referral system.

In order to stay competitive in today's “on-demand” marketplace, it is becoming increasingly important for businesses to deliver the right information to the right destination in a timely fashion. This information mobility is particularly important for businesses that utilize a mobile workforce, whereby employees are scattered among different locations.

One of the most common business models used today follows an organizational structure that categorizes specific activities or tasks with designated roles and departments. For example, a typical business may segment employees by departments, such as customer service, telemarketing/sales, repair, and billing, each of which is responsible for performing a unique set of tasks. In this business model, if a customer contacts the business for assistance with a problem, he/she may be transferred to the repair department. Likewise, if the customer inquires about a new product, he/she may be transferred to a sales associate. The delineation of these roles oftentimes leads to missed opportunities for the business, as one department may not be aware of situations that occur in another department. For example, a repair technician is sent out to a customer's home to perform repairs and, upon entering the home, notices an opportunity to upgrade the customer's equipment and/or service plan, an activity that is otherwise relegated to the sales department. In another example, a repair technician may be having a discussion with a customer who expresses an interest in a new product/service. Sales specialists are quite aware that these interests expressed by a customer can be fleeting; thus, there often exists a small window of opportunity, which may be lost if not acted upon in a timely manner.

What is needed, therefore, is a way to identify and exploit opportunities that may occur outside of the contexts within which typical business models are operated.

### BRIEF SUMMARY

Exemplary embodiments include a method, system, and computer program product for implementing a mobile referral system. The method includes presenting a referral form on a mobile device display, the referral form including data fields for receiving information and selections from a referring individual. The data fields include customer contact information fields, a customer type, and a referral type. Upon receiving the information and selections, the method includes determining a target destination for the referral based upon at least one of the customer type and the referral type, associating an identifier of the referring individual with the referral, and transmitting the referral and the identifier of the referring individual to the target destination.

Additional embodiments include a system for implementing a mobile referral system. The system includes a network-enabled mobile communications device including an input element, an output element, a modem, and a processor. The system also includes a referral system application executing on the mobile communications device. The referral system application performs a method. The method includes presenting a referral form on a mobile device display, the referral form including data fields for receiving information and selections from a referring individual. The data fields include customer contact information fields, a customer type, and a referral type. Upon receiving the information and selections, the method includes determining a target destination for the referral based upon at least one of the customer type and the referral type, associating an identifier of the referring individual with the referral, and transmitting the referral and the identifier of the referring individual to the target destination.

Further embodiments include a computer program product for implementing a mobile referral system. The computer program product includes instructions for executing a method. The method includes presenting a referral form on a mobile device display, the referral form including data fields for receiving information and selections from a referring individual. The data fields include customer contact information fields, a customer type, and a referral type. Upon receiving the information and selections, the method includes determining a target destination for the referral based upon at least one of the customer type and the referral type, associating an identifier of the referring individual with the referral, and transmitting the referral and the identifier of the referring individual to the target destination.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF DRAWINGS

Referring now to the drawings wherein like elements are numbered alike in the several FIGURES:

FIG. 1 is a block diagram of a system upon which the mobile referral system may be implemented in exemplary embodiments;

FIG. 2 is a flow diagram illustrating a process for implementing the mobile referral system services in exemplary embodiments;

FIG. 3 is a user interface screen of the mobile referral system illustrating a sample main menu in exemplary embodiments;

FIG. 4 is a user interface screen of the mobile referral system illustrating a sample set up screen in exemplary embodiments; and

FIGS. 5A-5C depict user interface screens of the referral system illustrating referral system fields and data in exemplary embodiments.

The detailed description explains exemplary embodiments, together with advantages and features, by way of example with reference to the drawings.

### DETAILED DESCRIPTION OF EXEMPLARY EMBODIMENTS

In accordance with exemplary embodiments, methods, systems, and computer program products for implementing a mobile referral system and services are provided. The mobile referral system enables an entity to identify and exploit opportunities that may occur outside of the contexts within which typical business models operate. The mobile referral system includes mobile devices through which referrals may be generated, and a network over which the referrals are transmitted. A host system is provided for processing and tracking the referrals, as well as crediting the referring individual for the referral. A referral may be defined as a documented process of directing an individual or entity to a particular location or resource for the purpose of addressing a discernible issue.

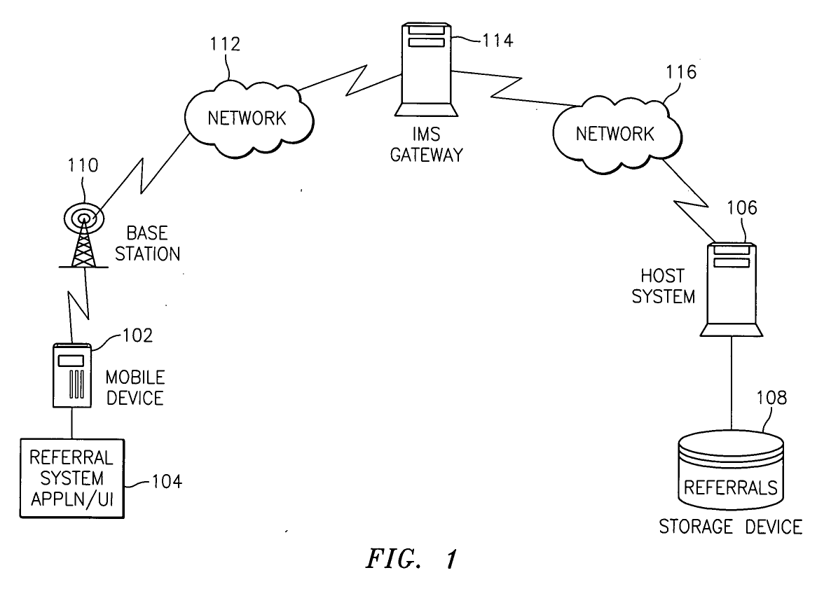

Turning now to FIG. 1, a system upon which the mobile referral system and services may be implemented in accordance with exemplary embodiments will now be described. The system of FIG. 1 includes a mobile device 102. Mobile device 102 may be an interactive pager, a cell phone, a personal digital assistant, a portable computer, or other suitable mobile communications device. For purposes of illustration, the mobile device 102 will be described herein as an interactive pager, such as a RIM 95x™ manufactured by Research In Motion® of Waterloo, Ontario. Mobile device 102 may include input/output elements, memory, a processor, and communications transmission and receiver elements (e.g., radio modem). In exemplary embodiments, the mobile device 102 executes a referral system application 104 for implementing the activities described herein. The mobile device 102 communicates over one or more networks such as network 112.

Also included in the system of FIG. 1 is a host system 106. Host system 106 is associated with an entity that receives and processes referrals transmitted by mobile devices, such as mobile device 102. For example, host system 106 may be implemented by a product and/or service provider whereby field employees operating mobile devices perform business-related activities during the course of their employment with an entity. These field employees may be, e.g., installers, repair technicians, or other types of individuals that travel as part of their job description. It will be understood, however, that the referral system services described herein are not limited to activities conducted during the scheduled workday. To the contrary, opportunities for providing referrals may arise outside of the referring individual's workday (e.g., at a social event).

Host system 106 may comprise a high-speed processor for handling the volume of referral system activities described herein. The host system 106 receives referrals that are generated by mobile devices and transmitted over one or more networks to the host system 106. Once received at the host system 106, the referrals may be forwarded to a corresponding address (e.g., a department or location) based upon the nature/subject of the referrals (e.g., as defined by a customer type, referral type, etc.). IN exemplary embodiments, a target destination for receiving and handling a referral may be determined by associating a referral type, item specified in a referral type selection, etc., with a particular location, group, or entity that is assigned to handle or resolve the referral. In exemplary embodiments, host system 106 is in communication with a storage device 108. Storage device 108 stores referrals received from mobile devices, as well as other information (e.g., customer records, employee IDs, mobile device IDs, etc.). Storage device 108 may be in direct communication with host system 106 (e.g., via cabling) or may communicate with host system 106 over a network.

Mobile device 102 communicates with host system 106 via one or more networks. As shown in FIG. 1, the mobile device 102 communicates with a base station 110, which in turn, communicates with network 112. The communication between mobile device 102 and base station 110 may be facilitated using one or more link layer protocols, such as Radio Open Systems Interface (ROSI) from Cingular Wireless® of Atlanta, Ga. Network 112 represents a radio network and supports wireless communications, such as Cingular's Core Mobitex Network. Base station 110 may communicate with network 112 via a general-purpose packet-switching protocol, such as X.25, developed by ITU/CCITT. Network 112 communicates with a dedicated gateway, or IP Multi-media Subsystem (IMS) gateway 114 via an X.25 or similar protocol. IMS gateway 114 serves as a gateway between radio-based communications and Internet Protocol (IP) communications. Using, for example, simple mail transfer protocol (SMTP), IMS gateway 114 forwards communications (e.g., referrals) over network 116 to the host system 106. Network 116 may be a packet-switched network, such as the Internet. It should be appreciated that the communications network shown in FIG. 1 is provided for illustrative purposes only. The features and functions of the mobile referral services described herein may be provided using any suitable network. For example, if the mobile device 102 is a cellular telephone, the network elements provided in the system of FIG. 1 may include cell towers that receive communications from the mobile device 102 and gateway elements, such as a mobile switching center that converts the communications signals to an IP-based format for processing by the host system 106.

Referrals may be generated by an operator of mobile device 102 via the referral system application 104 and transmitted over networks 112 and 116 to host system 106. These referrals may be tagged with specific address headers so that each referral is directed to a specific location at the host system 106. The tagging process may be configured so that a specific individual or department receives referrals based upon information contained in the referral (e.g., customer address, product or service selected, time of day to contact customer, etc.).

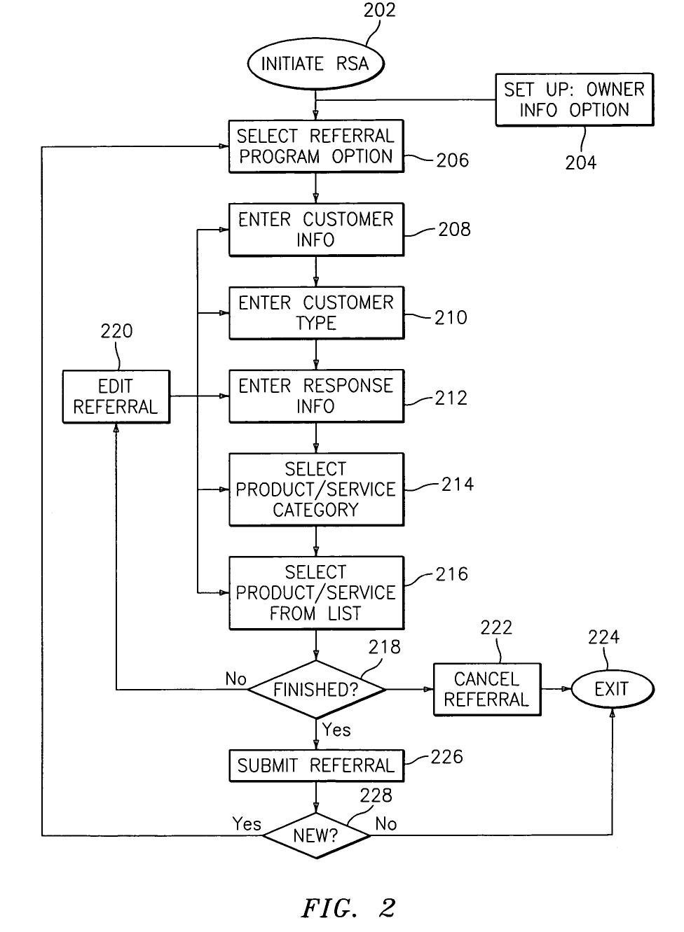

Turning now to FIG. 2, a flow diagram illustrating a process for implementing the mobile referral system services will now be described in accordance with exemplary embodiments. The referral system application 104, and any updates, may be downloaded to the mobile device 102, or the referral system application 104 may be installed on the device, e.g., at the time of manufacture. For purposes of illustration, the operator of the mobile device 102 will be referred to herein as “user” or “referring individual.” As indicated above, the operator may be a field employee of the host system entity, such as an installer, repair technician, sales representative, etc. In addition, the term “customer” as used herein refers to an individual on behalf of whom the referral is being generated.

For purposes of illustration, the activities described in FIG. 2 relate to a telecommunications service environment. However, it will be understood by those skilled in the art that the referral system services may be adapted for use in any type of business or activity in which information mobility is desired. The mobile referral system enables a referring individual (e.g., an operator or owner of a mobile device) to generate and transmit referrals to corresponding target addresses while out working in the field or while away from the office (e.g., at a social event). The mobile referral system provides standardized forms (via, e.g., data fields and selectable options) utilizing standard data elements that may be designed to inter-operate with existing legacy systems (e.g., web-based customer support applications). These standardized constructs, together with process rules governing the order of presentation, manner of transmission, translation rules, content, etc., of information elements enable the mobile referral system users (e.g., recipients of the referrals at the host system) to easily ascertain the specific details of the referral and integrate various referral activities (e.g., installations, repairs, upgrades, etc.) into existing business application activities. The standardized forms ensure accurate and complete referral information that are necessary to provide efficient referral responses.

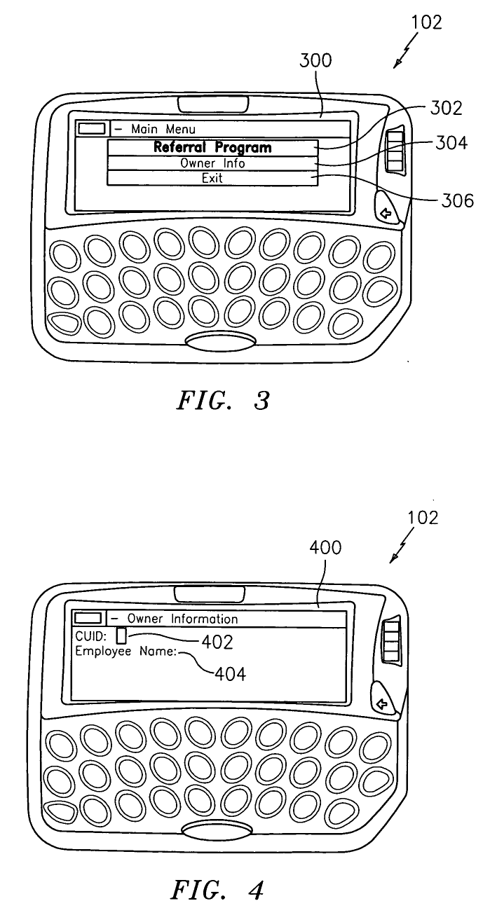

The user initiates the referral system application (RSA) 104 on the mobile device 102 at step 202. A main menu screen 300 is presented to the user on the mobile device 102, a sample of which is shown in FIG. 3. In accordance with exemplary embodiments, the main menu screen 300 of FIG. 3 includes three options: Referral program 302, Owner Info 304, and Exit 306. If this is the first time the user has initiated the referral system application 104, the user selects the Owner Info option 304 for conducting a one time only setup process. Upon selecting this option 304, an Owner Information screen is presented to the user at step 204 of FIG. 2. A sample Owner Information screen 400 presented on the mobile device 102 is shown in FIG. 4. The user enters an identifier (e.g., employee identifier) in CUID field 402 of the owner screen 400, which uniquely identifies the owner and associates the owner/operator with the device 102. The user then enters his/her name in field 404. This information is then stored in memory at the mobile device 102.

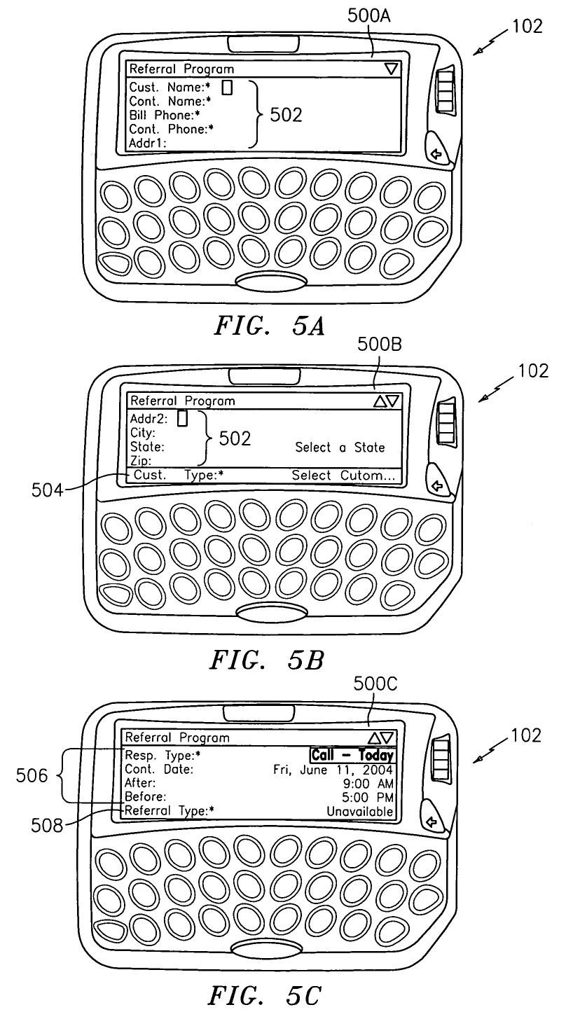

Once the setup process is complete, or alternatively, if the setup process has been previously conducted, the user selects the Referral Program option 302 on main menu screen 300 at step 206. A new screen is presented to the user on the mobile device 102 as shown in FIGS. 5A-5C. The user enters customer information in fields 502 of FIGS. 5A-5B at step 208. Customer information may include customer name (i.e., individual for which the referral is generated), a billing phone number, a contact phone number, and address. The user selects a customer type from customer type field 504 at step 210. In exemplary embodiments, the customer type selection distinguishes between home or personal consumers (e.g., residential customers), small business customers, large business customers, and even business partner entities (e.g., in the telecommunications environment, this may be a competitive local exchange carrier (CLEC)). The type of customer selected in step 210 may determine which product/service items will be made available to the user via the mobile device screen as described further herein.

The user then enters referral response information in response fields 506 at step 212. Response fields 506 may include response type, contact date, contact times (before and after times). In exemplary embodiments, the response type field enables the user to select between the current date (i.e., “Call-Today”) and a future date (i.e., “Call-Future”) depending upon the preferences of the customer. The response type field may be defaulted by the referral system application 104 to be the current date. If the customer desires to be contacted at a future date, the user selects “Call-Future.” The user is then prompted to enter a date in the contact date field. The “After” and “Before” fields enable the user to enter a time frame in which the customer desires to be contacted. By identifying specific dates and time frames, the amount of time host system representatives waste in contact attempts can be significantly diminished.

The user then selects a referral type (e.g., product or service category) in field 508 at step 214. As indicated above, the types of products/service options available for selection will depend upon the customer type selection made in step 210. For example, a product selection for a customer type “consumer” may include voice, data, wireless, customer premise equipment, video, security, customer service, print directory products and services, DirectTV®, and other items. Likewise, the product selections for a customer type “business” may include voice, data, wireless, customer premise equipment, video, security, customer service, print directory products and services and other items. Other customer types may be provided by the referral system application 104 (e.g., Customer Service and Irregular Plant). The product/service information is entered at step 216.

At step 218, it is determined whether the referral has been completed. Determination of the referral completion may be the submission of the referral when all fields marked with an asterisk on the form have been completed. The mobile device 102 and/or the referral system application 104 may include error checking capability, such that the user of the mobile device 102 receives an indication if all fields have not been filled out or filled out completely (e.g., a digit left off a telephone number). Once the referral system application 104 recognizes that the fields have been completed properly, the submission of the referral may be confirmed, e.g., by the appearance of the actual record of the referral on the mobile device 102 and/or the receipt of a referral confirmation number on the mobile device 102 confirming a successful transaction.

If the referral is not complete, two options are available to the user. At step 220, the user may edit the referral information by returning to any of steps 208-216. This may be accomplished, e.g., by selecting the “Hide Menu” option on the mobile device 102 (not shown). Alternatively, the user may cancel the referral without saving the information and the process ends at step 224. Otherwise, if the referral is complete, the user submits the referral by, e.g., pressing the control button/wheel and selecting “Submit” (not shown) on the mobile device 102 at step 226. The referral is then transmitted from the mobile device 102 to network 112 via base station 110. The referral is then sent to the IMS gateway 114 where it is translated and configured for transmission to the host system 106 via network 116.

Turning back to step 226, the user may continue to enter additional referrals, if desired. At step 228, it is determined whether the user has finished entering referrals. If not, the process returns to step 206. Otherwise, the process ends at step 224. A confirmation that the referral has been received by the host system 106 may be transmitted to the mobile device 102.

The host system 106 receives the referrals and tracks them through the referral process. Referrals may be stored in storage device 108 along with corresponding mobile device identifiers and/or employee identifiers, which associate the referral with the individual that generated the referral. Referring individuals may be given special incentives or rewards for each referral resulting in a product/service sale or reconciled. Reconciliation may be defined by resolving the issue subject to the referral, whereby the issue includes a repair action, installation, modification of existing product/services, a sale, or even information that is provided in response to a query.

As indicated above, the mobile referral system enables an entity to identify and exploit opportunities that may occur outside of the contexts within which a typical business model is operated. The mobile referral system includes mobile devices through which referrals may be generated, and a network over which the referrals are transmitted. A host system is provided for processing and tracking the referrals, as well as crediting the referring individual for providing the referral.

As described above, exemplary embodiments can be implemented in the form of computer-implemented processes and apparatuses for practicing those processes. Exemplary embodiments can also be implemented in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. Exemplary embodiments can also be implemented in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for providing referrals, comprising:
presenting a referral form on a mobile device display, the referral form including data fields for receiving information and selections from a referring individual, the data fields including:
customer contact information fields;
a customer type; and
a referral type;
upon receiving the information and selections, determining a target destination for the referral based upon at least one of the customer type and the referral type;
associating an identifier of the referring individual with the referral; and
transmitting the referral and the identifier of the referring individual to the target destination.

2. The method of claim 1, wherein the referring individual is a field employee comprising at least one of an installer, repair technician, and sales representative;
wherein the transmitting the referral and the identifier of the referring individual is performed over a network via the mobile device at a field location, the mobile device comprising at least one of:
an interactive pager;
a cellular telephone;
a personal digital assistant; and
a portable computer.

3. The method of claim 1, wherein the data fields further include response fields for receiving referral response details, the response fields including:
a response type field for specifying at least one of a current date and a future date;
a contact date field for specifying a date for contacting the customer if the response type is a future date; and
contact times for specifying a time frame in which the customer is to be contacted.

4. The method of claim 1, wherein the customer type is one of:
a small business;
a large business;
a business partner; and
a residential customer;
wherein selections available to the referring individual for the referral type field are determined based upon selections received from the referring individual via the customer type field.

5. The method of claim 4, wherein the selections available for the residential customer type include at least one of:
voice;
data;
wireless;
customer premise equipment;
video;
security;
customer service;
print directory product;
print directory service; and
DirectTV®.

6. The method of claim 4, wherein the selections available for a business customer type include:
voice;
data;
wireless;
customer premise equipment;
video;
security;
customer service;
print directory product;
print directory service.

7. The method of claim 1, wherein the target destination is determined by associating each item specified in the referral type with a corresponding entity assigned to resolve or reconcile issues relating to the item.

8. A system for providing referrals, comprising:
a network-enabled mobile communications device, comprising an input element, an output element, a modem, and a processor;
a referral system application executing on the mobile communications device, the referral system application performing the steps of:
presenting a referral form on the output element of the mobile device, the referral form including data fields for receiving information and selections from a referring individual, the data fields including:
customer contact information fields;
a customer type; and
a referral type;
upon receiving the information and selections via the input element, determining a target destination for the referral based upon at least one of the customer type and the referral type;
associating an identifier of the referring individual with the referral; and
transmitting the referral and the identifier of the referring individual to the target destination.

9. The system of claim 8, wherein the referring individual is a field employee comprising at least one of an installer, repair technician, and sales representative;
wherein the transmitting the referral and the identifier of the referring individual is performed over a network via the mobile device at a field location, the mobile device comprising at least one of:
an interactive pager;
a cellular telephone;
a personal digital assistant; and
a portable computer.

10. The system of claim 8, wherein the data fields further include response fields for receiving referral response details, the response fields including:
a response type field for specifying at least one of a current date and a future date;
a contact date field for specifying a date for contacting the customer if the response type is a future date; and
contact times for specifying a time frame in which the customer is to be contacted.

11. The system of claim 8, wherein the customer type is one of:
small business;
large business;
business partner; and
residential customer;
wherein selections available to the referring individual for the referral type field are determined based upon selections received from the referring individual via the customer type field.

12. The system of claim 11, wherein the selections available for the residential customer type include at least one of:
voice;
data;
wireless;
customer premise equipment;
video;
security;
customer service;
print directory product;
print directory service; and
DirectTV®.

13. The system of claim 11, wherein the selections available for a business customer type include:
voice;
data;
wireless;
customer premise equipment;
video;
security;
customer service;
print directory product;
print directory service.

14. A computer program product for providing referrals, the computer program product including instructions for implementing a method comprising the steps of:
presenting a referral form on a mobile device display, the referral form including data fields for receiving information and selections from a referring individual, the data fields including:
customer contact information fields;
a customer type; and
a referral type;
upon receiving the information and selections, determining a target destination for the referral based upon at least one of the customer type and the referral type;
associating an identifier of the referring individual with the referral; and
transmitting the referral and the identifier of the referring individual to the target destination.

15. The computer program product of claim 14, wherein the referring individual is a field employee comprising at least one of an installer, repair technician, and sales representative;
wherein the transmitting the referral and the identifier of the referring individual is performed over a network via the mobile device at a field location, the mobile device comprising at least one of:
an interactive pager;
a cellular telephone;
a personal digital assistant; and
a portable computer.

16. The computer program product of claim 14, wherein the data fields further include response fields for receiving referral response details, the response fields including:
a response type field for specifying at least one of a current date and a future date;
a contact date field for specifying a date for contacting the customer if the response type is a future date; and
contact times for specifying a time frame in which the customer is to be contacted.

17. The computer program product of claim 14, wherein the customer type is one of:
small business;
large business;
business partner; and
residential customer;
wherein selections available to the referring individual for the referral type field are determined based upon selections received from the referring individual via the customer type field.

18. The computer program product of claim 14, wherein the selections available for the residential customer type include at least one of:
voice;
data;
wireless;
customer premise equipment;
video;
security;
customer service;
print directory product;
print directory service; and
DirectTV®.

19. The computer program product of claim 17, wherein the selections available for a business customer type include:
voice;
data;
wireless;
customer premise equipment;
video;
security;
customer service;
print directory product;
print directory service.

20. The computer program product of claim 14, wherein the target destination is determined by associating each item specified in the referral type with a corresponding entity assigned to resolve or reconcile issues relating to the item.
